(19) United States
(12) Patent Application Publication
(10) Pub. No.: US 2018/0350020 A1
(43) Pub. Date: Dec. 6, 2018

(54) System and Method for Dynamically Resolving an Issue Using Community Input

(71) Applicant: Tuka Gafari, Aptos, CA (US)

(72) Inventor: Tuka Gafari, Aptos, CA (US)

(21) Appl. No.: 15/996,500

(22) Filed: Jun. 3, 2018

Related U.S. Application Data
(60) Provisional application No. 62/515,360, filed on Jun. 5, 2017.

(51) Int. Cl. G06Q 50/26; G07C 13/00

(52) U.S. Cl. CPC G06Q 50/26; G06Q 2230/00; G07C 13/00

(57) ABSTRACT

One embodiment of the present application is to allow a user who has a disputable issue to solicit opinions and obtain a user-based consensus regarding the disputable issue. In some embodiments, the system and method receive case information from an initiator, determine a voter candidate, send a voter invitation to the voter candidate, receive an acceptance to be a voter from the voter candidate, supply the argument information of the initiator to the voter, receive a vote from the voter, and determine an outcome based on at least the vote. The user can optimize several variables to meet the needs of the user to effectively resolve the disputed issue, such as by requesting another user to respond to the disputed issue, set time constraints, set limits to the number of participants, select filters who can participate, limit other uses from participating, and set document and evidence parameters. The system and method may assist in preparation for parties to solve a dispute based on opinions or better prepare for court if a dispute is not resolved.

### CROSS-REFERENCE TO RELATED APPLICATIONS

This application claims benefit of U.S. provisional patent application entitled “System and Method for Dynamically Resolving an Issue Using Community Input,” filed on Jun. 5, 2017 and having a Ser. No. 62/515,360.

### BACKGROUND OF THE INVENTION

### Field of the Invention

The present invention relates generally to resolving disputes between parties, and more particularly to a system and method for allowing users to set boundaries within a structured and dynamic approach to resolve an issue using community input.

### Description of Related Art

Conventionally, users who have an unresolved legal dispute resort to the judicial system. Using the judicial system could cost a great deal of money and time. Also, to avoid high costs of litigation, or as per local judicial procedure, users may arbitrate to attempt to resolve a dispute. Conventional systems may be cost prohibitive to settle disputes that have low or no monetary damages to recover.

Recently, existing mechanisms, such as social media, are taking a greater role to provide means for posting opinions and expressing ideas, and allowing for feedback in the way of comments and suggestions, such as blogs. Often, these mechanisms fail to provide a structure that is sufficiently useful to dynamically resolve an issue. What is needed is an automated system to dynamically resolve a disputed issue that provides sufficient flexibility to meet the needs of the users and that provides a clear easy to follow process.

### SUMMARY OF THE INVENTION

A system and method to allow a user to solicit opinions and obtain a user-based consensus regarding a disputable issue. The user may request another user to respond to the disputed issue. In some embodiments, the system and method includes data from an initiator to at least one opposing side with approved supporting documents from the opposing side. If another user is not requested to dispute an issue, then the method may create a time sensitive posting that may be responded to by any other user, such as if displayed on an electronic bulletin board. The system and method may include limiting access to data to users involved in the case, and limiting submissions of data, such as limiting submission of opinions to experts and limiting submissions of votes by voters. The system and method allows an initiating user to set several parameters to control a process of the case, such as payment to experts, voter numbers, vote numbers, expert numbers, and filters to selectively invite particular experts and voters. The system and method may assist in preparation for parties to solve a dispute based on opinions or better prepare for court if a dispute is not resolved.

In one embodiment, a dispute resolution method receives case information from an initiator, wherein the case data contains argumenta information; based on the case information, determines at least one voter candidate; sends a voter invitation to each of the at least one voter candidate; receives an acceptance to be a voter from a voter candidate of the at least one voter candidate; supplies the argument information of the initiator to the voter, receives a vote from the voter, and determines an outcome based on at least the vote. In various embodiments the system is configured to perform the methods as described herein, and as for convenience, the description may focus on either the system or method, but is not limited to either of the system or method unless specified.

The dispute resolution may further based on the initiation data, send a respondent invitation to a respondent; receive an acceptance to the respondent invitation from the respondent; notify the initiator of the acceptance; receive argument information from the respondent; and supply to the voter access to the argument information of the respondent.

The dispute resolution method may further, after receive a closing argument from the initiator or a closing argument from the respondent, send to the other of the initiator or the respondent, a request for a closing argument; and receive the closing argument from the other.

The dispute resolution method may further, after receiving at least one initiator document of the argument information, prevent access by the voter to the at least one initiator document; receive from the respondent an approval of the at least one initiator document; and after receiving the approval, supply to the voter access to the least one initiator document.

The dispute resolution method may further, after receiving at least one initiator document of the argument information, receive from the respondent an approval for the at least one initiator document; and supply to the voter access to the approved at least one initiator document.

The dispute resolution method may further, after receiving at least one initiator document of the argument information, receive from the respondent a conditional approval to the at least one initiator document; receive a modified version of the at least one initiator document; receive from the respondent an approval for the modified version of the at least one initiator document; and supply to the voter access to the approved modified version.

The dispute resolution method may further, wherein the case data comprises a number of voters, the method determine if the number of voters is equal to a total number of acceptances received from the at least one voter candidate; and if the determination is that there are fewer acceptances than the number of voters, repeat until equal, determine another at least one voter candidate, and receive at least one favorable response from the another at least one voter candidate.

The dispute resolution method may further, wherein the case data comprises a number of voter, determine if the number of votes is equal to a total number of votes received from voters; and if the determination is that there are fewer received votes than the number of votes, and time has expired for the voter to vote, repeat until equal, determine another at least one voter candidate, receive at least one favorable response from the another at least one voter candidate, receive an acceptance from the voter candidate of the at least one voter candidate, and receive a vote from the voter.

The dispute resolution method may further, wherein the case data comprises a number of experts, determine if the number of experts is equal to a total number of acceptances received from the at least one expert candidate; and if the determination is that there are fewer acceptances than the number of experts, repeat until equal, determine another at least one expert candidate, and receive at least one favorable response from the another at least one expert candidate.

The dispute resolution method may further, based on the initiation data, create a case; and allow access to the case by users.

In another embodiment, a dispute resolution system includes a receiver configured to receive case information from an initiator, wherein the case data contains argumenta information; a voter determiner configured to, based on the case information, determine at least one voter candidate; a sender configured to send a voter invitation to each of the at least one voter candidate; a receiver configured to receive an acceptance to be a voter from a voter candidate of the at least one voter candidate; a supplier configured to supply the argument information of the initiator to the voter, wherein the receiver is further configured to receive a vote from the voter; and a determiner configured to determine an outcome based on at least the vote.

In another embodiment, a non-transitory computer readable storage medium having stored thereon, a computer program, the computer program when executed by a computer causes the computer to perform dispute resolution steps including, receiving case information from an initiator, wherein the case data contains argumenta information; based on the case information, determining at least one voter candidate;

sending a voter invitation to each of the at least one voter candidate; receiving an acceptance to be a voter from a voter candidate of the at least one voter candidate; supplying the argument information of the initiator to the voter, receiving a vote from the voter, and determining an outcome based on at least the vote.

### BRIEF DESCRIPTION OF THE DRAWINGS

FIG. 1 illustrates an exemplary environment for resolving disputes in a network environment;

FIG. 2 is a block diagram of a resolution forum;

FIG. 3 is a block diagram of a case module;

FIG. 4 is a flow diagram of a process for resolving a dispute;

FIG. 5 is a flow diagram for joining a respondent and obtaining respondent case data;

FIG. 6 is a flow diagram for obtaining an expert and an opinion; and

FIG. 7 is a flow diagram for obtaining a sufficiency of voters and a sufficiency of votes.

### DETAILED DESCRIPTION

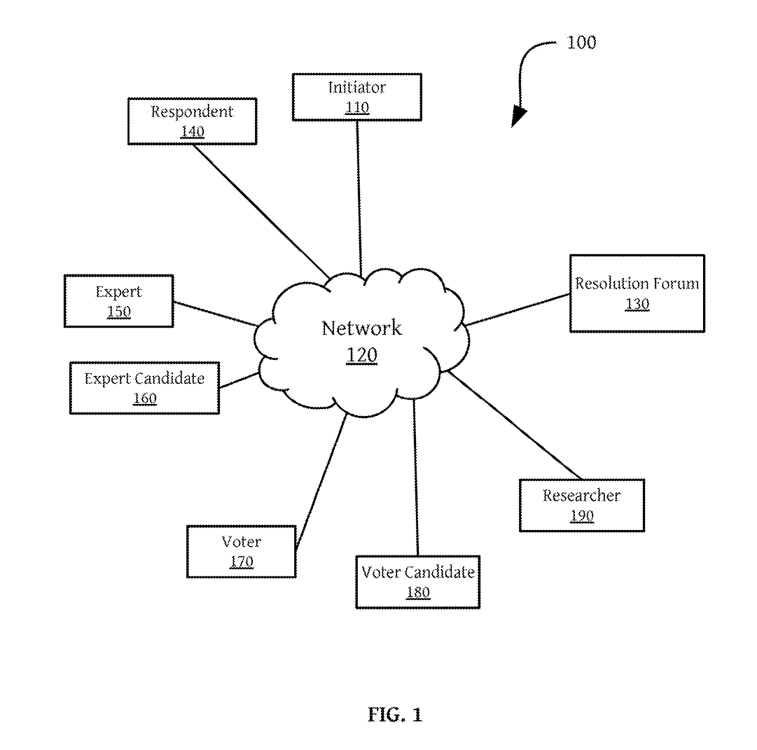

FIG. 1 illustrates an exemplary environment 100 for resolving disputes in a network environment. The environment 100 allows for users of a resolution forum 130 to resolve a dispute. The environment 100 includes an initiator 110, a network 120, a resolution forum 130, and a respondent 140. In one embodiment the environment also includes an expert 150, an expert candidate 160, a voter 170, a voter candidate 180, and a researcher 190. The users communicate with the resolution forum via the network 120. In other embodiments, two or more different types of users in addition to an optional researcher participate in a case.

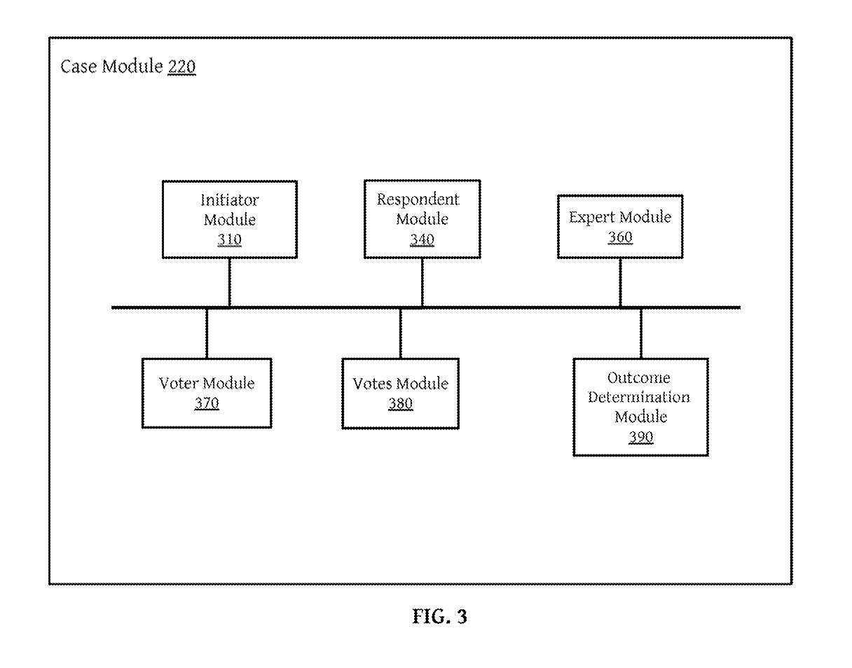

A user of the resolution forum 130 is any one of the initiator 110, the respondent 140, the expert 150, the expert candidate 160, the voter 170, the voter candidate 180 and the researcher 190. In one embodiment, the user provides user information prior to obtaining access to the resolution forum 130. User information includes a name of the user and contact information. User information may also include information used to identify an expert candidate 160, and voter candidate 180. A discussion on the types of information and the process to identify a user candidate is discussed herein and in particular with reference to FIGS. 3, 6 and 7.

The initiator 110 initiates a case by sending information, case data, to the resolution forum 130. The case data supplied by the initiator 110 may include initiator supplied argument information, initiator supplied filter data, initiator supplied case parameters, and optional respondent contact information. The respondent contact information may contain a name or contact information of the respondent 140, such as an email address.

The case data contains specific information about the case, such as argument information, information related to making a decision on how to vote; filter data, data used to determine experts and voters; and case parameters, data used by modules of the case module 220 to conduct the case. Case data may be in any format that can be transmitted over the internet, such as text documents, picture, diagrams, videos and audio. In various embodiments, the types of data are reflected by the users participating in the case, such as if there are no experts in the cases, then there are no opinions. The timing of the submission of case data may vary from case to case. In one embodiment, all the case data is submitted in the beginning, thereby allowing for near complete automation. In other embodiments, the case data is submitted on an as needed bases, thereby minimizing the time and effort required by a user in the situation where a case is abandoned. For example, if the initiator 110 identifies a respondent 140, then the initiator waits until after the respondent 140 has accepted an invitation to participate in the case before the initiator 140 submits supporting documents, statements of law, and any other evidence; and waits until after both disputers have submitted most or all of the argument information before submitting filter data and case parameters.

The argument information includes any information provided by the disputers to be used by the experts to draft an opinion and by the voters to decide on how to cast a vote, for example such as, a case title, a statement of dispute, facts of the case, statements of law, case type (such as landlord tenant dispute, car accident), incident date (where appropriate), evidence, supporting documents, links to websites if the website is related to the dispute, analysis of the law, and arguments; and opinions, information generated by experts and used by the voters to cast a vote, as discussed herein. In one embodiment in which a respondent participates, the argument information may include respondent contact information provided by the initiator, to be used by the case module 220 to contact the respondent. In another embodiment, argument information is provided by the initiator.

The filter data includes information for filtering by the filter module 230, such as for example, a profession, age, and any other data to filter as discussed herein.

The case parameters include information related to a case, such as for example, an expert number, a voter number, a vote number, a vote, a time to respond, a time to accept, a time to submit, and as discussed herein. The case data that the initiator 110 may provide includes, a maximum time for the case, a maximum time for the respondent 140 to respond to a request to join, a minimum number of voting users, and a minimum number of votes. The dispute may be any statement or question that can be argued, such as a science question, for example, “Do black holes exist?”, or may be a legal question, for example “Should I recover damages from a dog bite?”. Case data may be entered by the initiator 110 in text form from a user device (not depicted). Case data may be entered by typing text and/or clicking options on a webpage provided to the initiator 110 by the resolution forum 130.

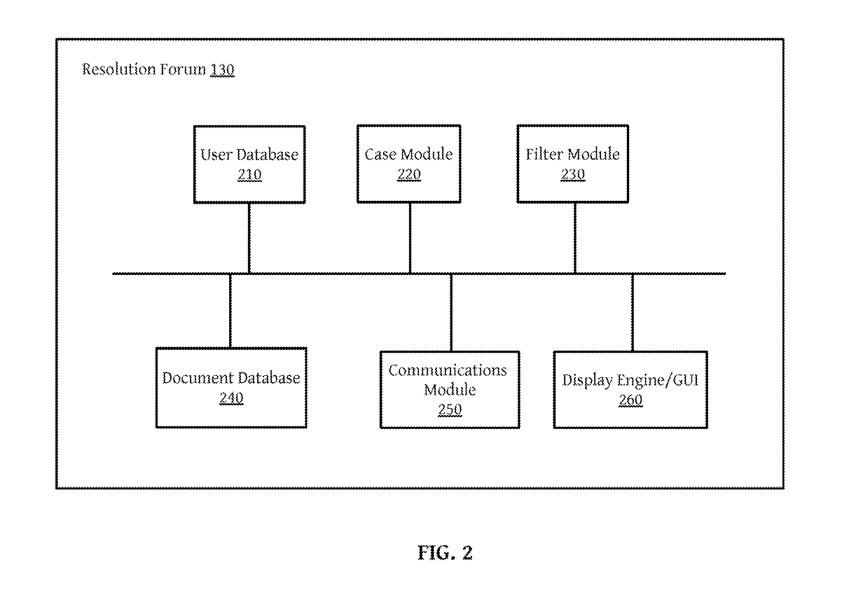

In one embodiment, the case data contains expert request information, and may contain expert filter information. In another embodiment the case data contains voting user information, and may contain voting user filters. In further embodiments, the case data contains expert request information and voting user information, as well as may optionally contain filter information for none, one or both of the expert candidate 160 and the voter candidate 180. More detail regarding filtering is further discussed herein, and specifically with reference to FIG. 2.

In another embodiment, the case data contains a respondent participation request or a respondent invitation which is a request for another user, or not-yet-registered user, to be on an opposing side of the initiator 110.

The supporting documents are files containing support of the dispute. Both the initiator 110 and the respondent 140 may file supporting documents, herein referred to as initiator document and respondent document, respectively. The supporting documents may in any format supported by the resolution forum 130, such as, for example, MS word documents and other text files, Portable Document Format and other image files and the like. In various embodiments, supporting documents may be sent as files attached to communications, uploaded via a webpage, and/or entered as text via a webpage provided to the initiator 110 by the resolution forum 130.

The resolution forum 130 manages the case from case creation to archiving. In the beginning of each case, the resolution forum 130 receives information from the initiator 110. Based on the received information, the resolution forum 130 processes the case until completion, and then archives the case for future reference and research. The functions of the resolution forum 130 are discussed herein, and in particular, with reference to FIG. 2.

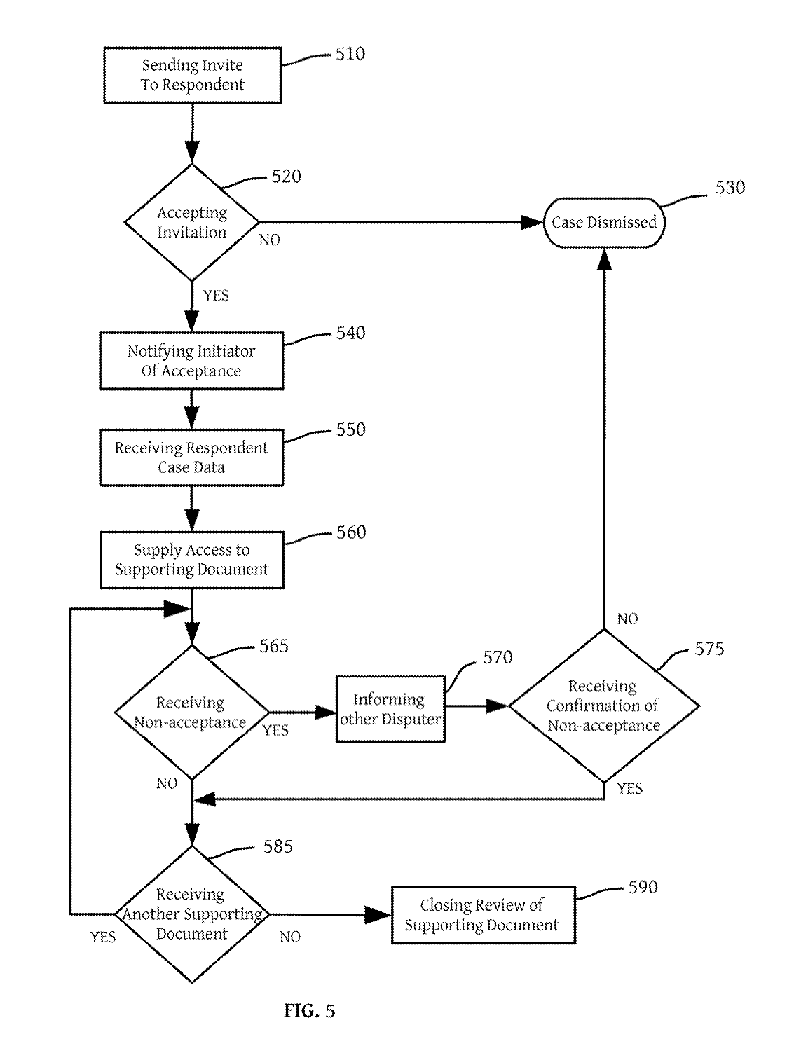

The respondent 140 is a user identified by the initiator 110 of which both users have an issue or dispute that they both desire to better understand views of the opposing as well as may request an opinion from an expert. The respondent also desires to resolve the issue or dispute. A disputer is defined as either the initiator 110 or the respondent 140; and the term disputers is defined as one or more initiators; or one or more initiators and/or respondents. The respondent 140 is further discussed herein, and in particular, with reference to FIG. 5.

The expert 150 is believed to be knowledgeable in one or more particular areas of knowledge. In one embodiment, the role of the expert 150 is to review the dispute and supply an opinion on the dispute. The expert 150 may be a paid expert or the expert may be provide an opinion free of charge, depending of the desire of the disputer. A user may also indicate that they will only be an expert if paid. In one embodiment, the filter module 230 gives the option to filter one or more experts to have legal experience, such as attorneys, judges, if a legal opinion is desired.

The selection of using and the selection process of the expert 150 is case dependent. In one embodiment, the disputer indirectly obtains the experts from a pool of users in the user database by using selected filters. In another embodiment, the disputer identifies a person to be an expert and by submitting contact information to the resolution forum 130, the resolution forum 130 then sends an invitation to the person requesting that the person sign up as a user become the expert 150. In a further embodiment, the disputer selects an expert from a list of potential exports with respective profiles as provided by the resolution forum 130, where the potential experts have been filtered by a filter module using filters selected by the disputer.

In another embodiment, the disputers may agree to use a judicial expert (not depicted), such as a judge, an arbitrator or a user with judicial experience, in additional to or in lieu of other experts. The judicial expert may provide legal guidance or impartial advice to the users participating in the case. The case module 230 would allow for communications between the judicial expert and the other users of the case throughout the case. By using a judicial expert, some legal issues may be resolved in an unbiased way by a dedicated user who is knowledgeable about the law and legal proceedings. In various embodiments, the filter module 230 restricts the selection of a judicial expert to jurisdictions that would permit such a judicial expert to preside over a dispute, thereby allowing the resolution forum 130 to follow related laws. Using judicial experts would allow users of the resolution forum 130 to participant in a traditional alternate dispute resolution, that is, to include knowledge from legal professionals as experts, such as arbitrators, judges and attorneys, and have additional benefits.

Some of these additional benefits of using the resolution forum 130 include, for example, allowing for the selection and filtering users, being paperless, allowing for faster responses, determining a resolution at little or no cost, obtaining a collection of argument information in one package, and obtaining a resolution in a matter of days, weeks or any other desired time.

In another embodiment, the disputers select the case to be open for solicitation by an arbitrator. When open for salutation, a user who has arbitration experience may offer services to the disputers by reviewing pending cases listed by the resolution forum 130 in a community area and then contacting the disputers related to the case which has been created as being open for solicitation. The disputers may tag the case as requesting an arbitrator for pay, in which the pay would be listed with the case. This process may allow for a faster selection of an arbitrator.

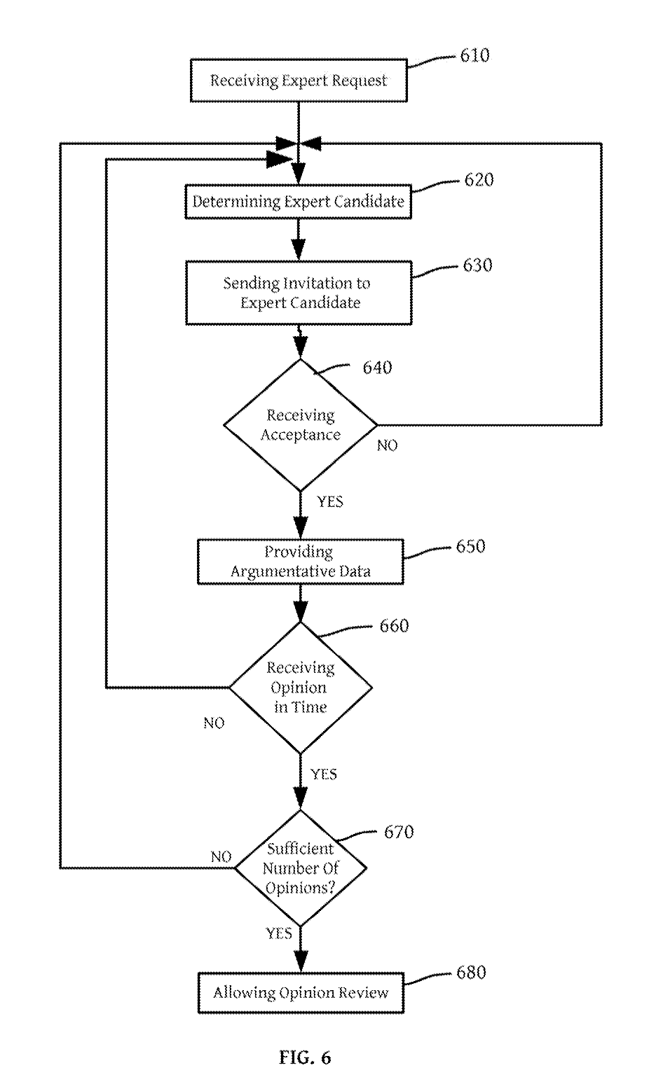

The expert candidate 160 is a user who is identified by the resolution forum 130 as a potential expert. The expert 150 and the expert candidate 160 are further discussed herein, and in particular, with reference to FIG. 6.

The voter 170 votes on the case based on submissions by the initiator 110 and the respondent 140. In one embodiment, the number of the voters in any particular case will be determined by the initiator 110. In another embodiment, the initiator 110 gives permission to the respondent 140 to request a change in the number of voters, thereby allowing the respondent 140 to confirm or modify the number of voters, which allows for a mutual and cooperative resolution.

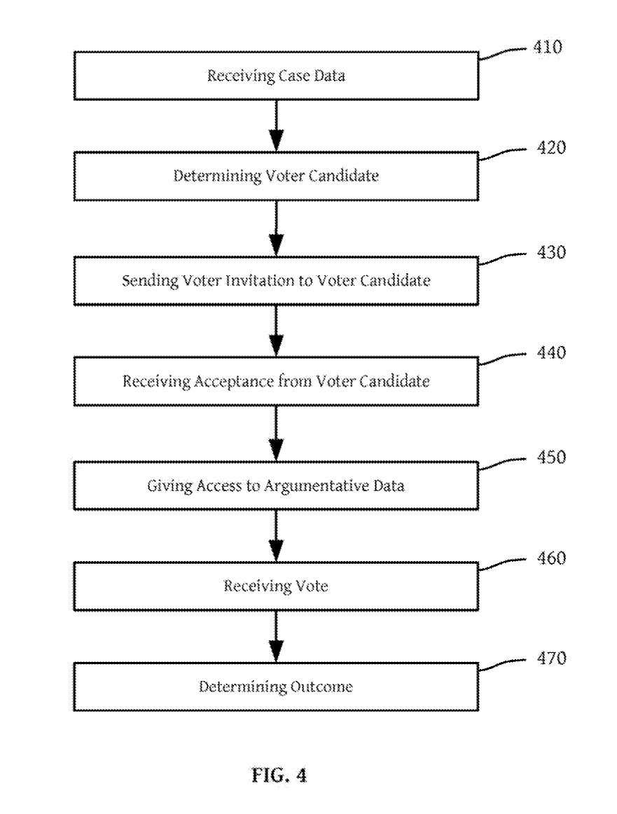

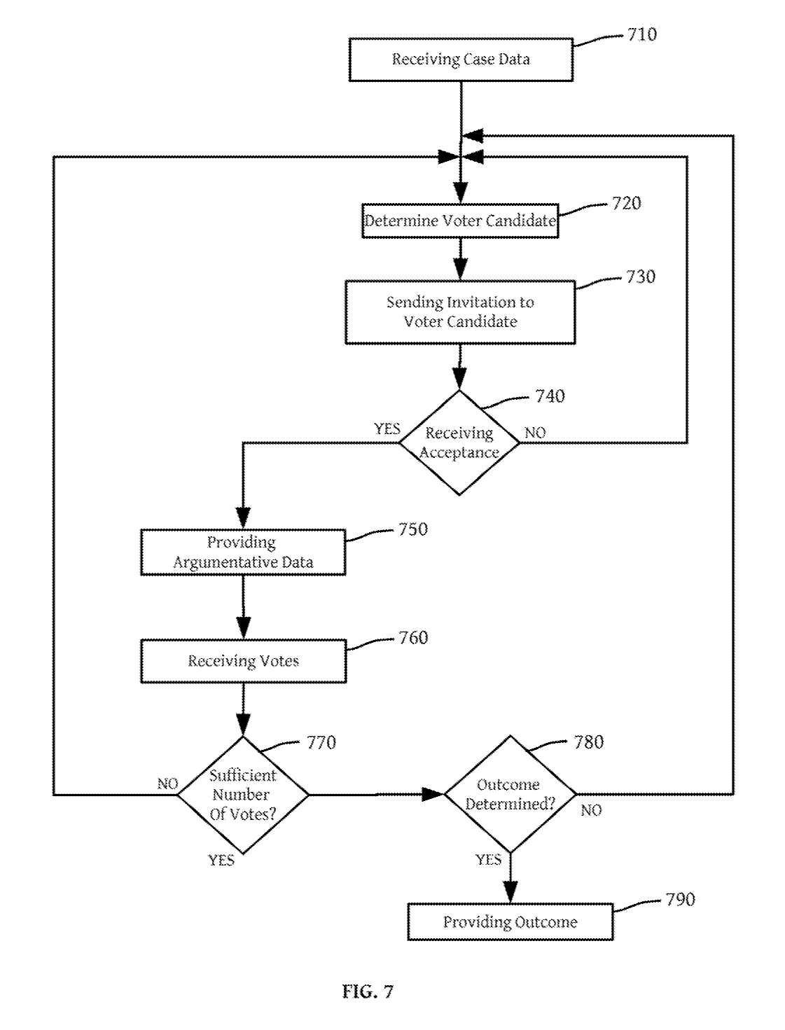

The voter candidate 180 is a user who is identified by the resolution forum 130 as a potential voter. Details are discussed herein. The voter 170 and voter candidate 180 are further discussed herein, and in particular, with reference to FIGS. 4 and 7.

Hereinafter, a reference in a singular from of the expert 150, the expert candidate 160, the voter 170 and the voter candidate 180 may be taken as a plurality of users unless otherwise specified.

The researcher 190 is any user who accesses the forum module to review cases that have been closed, a case that has had an outcome determined, and are open for viewing. The researcher 190 may search for cases similar to a dispute of the researcher 190 prior to starting a case to determine if the dispute could be resolved without starting another case. Researches potentially have access to wisdom of the world at the convenience using a local terminal. For example, if the researcher 190 wants to compare a contract issue in a foreign country in preparation for a business trip, the researcher 190 may search the document database 240 for related cases.

FIG. 2 is a block diagram of a resolution forum 130. The resolution forum 130 includes and allows communications between a user database 210, a case module 220, a filter module 230, a document database 240, a communications module 250, and a display engine/GUI 260.

The user database 210 contains information about each user, such as name, alias name, address, phone numbers, emails, preferred means of communication, professional organization members, clubs, activities, hobbies, licenses, professions, work history, vacation activity, non-responsive (as discussed herein), and any other information that be used to filter users. The alias name may be seen by other users and used to maintain anonymity of the users. In one embodiment, users can choose a different alias for each case. In another embodiment, the resolution forum 130 assigns a different alias to each user so as to keep identities private. User information may include user communication preferences.

Typically, the user database 210 is populated with information collected when users register and supply name and contact information prior to dealing with a case. The user database 210 may further collect information by optional user updates so as to update the information.

In various embodiments, the user database 210 may receive information, such as a name or contact information, of a potential expert from the initiator 110 or the respondent 140. Here, the potential expert would receive a communication from the resolution forum 130 requesting the potential expert to register with the resolution forum 130 so as to become the expert 150 of the case. This allows for an expansion of a user base from within resolution forum 130, as the expert 150 would not need to be a user prior to receiving a communication from the resolution forum 130.

The case module 220 manages particulars of interactions of the users for a specific case. Each case is treated separately. Each case starts with one initiator 110 who submits an initial issue to be resolved. In one embodiment the initial issue may have sub-issues. In other embodiments, the initial issue may be modified. In further embodiments, other issues may presented after the initial issue.

The case module 220 allows the initiator 110 to designate the case to be private (sealed) or public, accessible to the public via searches. An examples of when the initiator 110 or the respondent 140, (the disputer), desires the case to be private is if the information related to the case is specific enough to have allow for the identity of the user to become known. Private cases help to maintain anonymity of personal and sensitive information, such as for example, medical issues, religious beliefs, legal or similar information. When designated a private case, the disputers may opt to have no experts or voters, that is, only the disputers. This has the advantage of letting two people resolve an issue on equal grounds without the emotional stress that may arise if meeting in-person or dealing with each other directly; or allow for distant users to resolve an issue in an objective manner.

By allowing users equal standing to resolve an issue, users may be more willing to resolve an issue rather than not resolving the issue at all, that is, let the issue remain unresolved.

In various embodiments to contain dissemination of the issue, the voter candidate 180 is denied access a voter 170 to the some or all of the argument information until after the voter candidate 180 accepts the invitation to be a voter. That is, the access of argument information would be restricted to only the disputers prior to voters being established, thereby maintaining a need-to-know basis throughout and after the case has closed. In other embodiments, the disputers would need to agree to transition the case from private to public status before other users could access the case. In another embodiment, the disputers could limit the number of experts to one or a few, thereby limiting the dissemination of the issue.

In another embodiment in a private case, the case module 220 opens access to the expert 150 and the voter 170 only while a response is pending from the expert, and after receiving a response restricts access thereafter, thus leaving only the disputers to have access to the case.

In various embodiments, the resolution forum 130 will purge the case after receiving a request to purge from the initiator, if no respondent, or from both of the disputers.

In one embodiment, a case that has a private status defaults to public after the resolution forum 130 receives a request from one of the disputers to change the status to public. In another embodiments, the resolution forum 130 changes the private status to public status after a certain time, such as one year, five years, or a specific time agreed to by the disputers. As having the case in the public domain serves the interest of public, in one embodiment the resolution forum 130 presents options to the disputers during the case and, if still private after the case, presents options to the disputers requesting that the disputers changes the status of the case to be publicly accessed.

By allowing users to select different privacy levels and options, users may be more willing to resolve an issue rather than not resolving the issue at all, that is, let the issue remain unresolved.

In various embodiment, the case module 220 periodically purges dismissed cases from the system, thereby saving storage space and reducing risk of exposure of private information. The case module 220 is further discussed herein, and in particular with reference to FIG. 3.

The filter module 230 identifies an expert candidate 160 and a voter candidate 180 by using filter information supplied by the disputer on data supplied by users to allow the disputer to obtain experts and voters who have certain qualifications as optionally selected by the disputer. Filters can be positive or negative, that is having a certain quality or lacking a certain quality. In other words, a filter selection is a selection for particular filter fields to be satisfies or not to be satisfied. For example, the initiator 110 desires to have voters who are engineers, and not do not live in California, and so selects filters to indicate engineering profession and to filter out users who live in California. This allows for a plethora of options to obtain experts and voters specifically tailored to the specific interest of the disputers. In another example the filter can include or exclude users based on area code, company, or any other filter field. In one embodiment, filter field selections may be the same or different for experts and voters by one or both of the disputers, that is, each of the initiator 110 and the respondent 140 may select different fields to be used by the filter module 230.

User information that is used by the filter module for both being an expert candidate or a voter candidate may include, to name a few, industry expertise, profession type, work history, gender, age, address, sexual preference, criminal background, hobbies, activities, family members, medical history, desire to be an expert, desire to be a non-paid expert, desire to be a paid expert, desire to be a voter, and vacation status.

In one embodiment, the filter module 230 supplies fields to users via the communications module 250 and/or the display engine/GUI 260 to allow users to select certain fields that the user would like to be known to be competent. In one embodiment, the filter module 230 accesses the information stored in the user database 210. In another embodiment, the filter module stores filtering information separate from the user database 210.

The filter module repeats the identification candidates until a sufficient number of experts and voters are respectfully established. Similarly, the filter module 230 may need to repeat the identification of voter candidates 180 until a sufficient number of votes is received. More detail of the filter module process is discussed herein and in particular with reference to FIGS. 4, 6 and 7.

In one embodiment of setting the filters for the filter module 230, after the initiator 110 initially sets filter fields, the respondent 140 learns the fields and then can either accept the fields as are or request a change, and if both disputers are not satisfied, the case will be abandoned. In another embodiment, both disputers select and agree to the filters and select the number of voters who are filtered by the filters. For example, the disputers may select the filters for all the voters, thereby being unbiased, may use an equal number of voters selected by initiator selected filters and respondent selected filters, there being equal, or may decide to use a non-equal number of voters to be determined by filters selected by the disputers, so as to persuade one party to use the resolution forum or to compensate for some other factors, such as damages, ability to supply evidence, prior arrangements or understandings, or any other factors that the disputers believe would offset something to obtain an agreeable environment. For example, if the initiator has damages in the amount of $100 and the respondent has no legal duty to pay the initiator, then the respondent may agree to use the resolution forum if the disputers use filters selected by the respondent to obtain twenty voters and filters selected by the initiator for five voters. This would allow for disputers to come to resolve a dispute by equaling the playing field of an otherwise unresolvable dispute, by using a system that is biased to obtain an agreed upon resolution.

Filters vary in many way, such as, being a positive, that is a user has a particular trait, being negative, that is, a user does not have a particular trait, being a range, for example, five or more years of work experience as an engineer, or any other way to filter users from the user database 210, such as for example, “a user who likes three different sports, but not swimming”.

For example, a disputer can set a filter of the filter module 230 regarding landlord-tenant case to have only real estate agents based in California (one or more professions, in one or more geographic locations). This allows the disputer, who may be a landlord, to have experts and/or voters who are knowledgeable of the field. A negated example along the same line is a disputer who is a tenant and may not want to have any real estate agent as a voter. As in another example about a gun control issue, the disputer may or may not want to include residents from states with strong gun control policy, and select filters appropriately. Another example is with a divorce case between a married couple, where anonymity is important to them to exclude neighbors, family and friends, such that the disputers provide phone numbers, addresses, names and emails of people to exclude from the case. As the methods to include users or prevent users from participating in a case is extension, and commonly known, such as by using company emails to determine employer, few examples are provided herein. An example of a company limited case, the disputers may use filters to only allow users with a company email, such as for example an email ending with @intel.com to include only users who work for Intel.

The filter module 230 may be used to set filters to maintain the anonymity of the disputers, such as by using filters based on a location, such as a town, to prevent a selection of a voter candidate who lives in the same city as a disputer. In one embodiment, a disputer may select an anonymity option, whereby the filter module 230 selects default filters so that voter candidates are not located in the same area, do not work for the same company, have not attended the same schools, do not attend the same clubs or activities, such a gym or church, and anything else that might be used to identify the disputer. In another embodiment, a disputer may set a filter to apply as a cross-filter, so that filters apply to both of the voters selected by the initiator and the disputer, that is for example, filter module 230 filters out voter candidates who live in the same cities as the initiator and the respondent for voters obtained by filters by the initiator and the respondent. In various embodiments, if one of the disputers does not select to be anonymous and the other does, the filter module 230 will filter out voter candidates for the disputer who selected to be anonymous. In other embodiments, either disputers may agree or disagree to allow some, none or all cross-filters to apply. Anonymity selections may help users to decide to participate in the resolution forum 130, as identities can be maintained private.

The document database 240 stores supporting documents for the resolution forum 130. In one embodiment supporting documents are stored by case indexing. In another embodiment, supporting documents are stored by privacy and case indexing. In various embodiments, supporting documents are marked for privacy to be viewed by the disputers alone, by the disputers and experts alone, by the disputers, the experts and the voters, or may be viewed by any user. In various embodiments, the document database 240 may store supporting documents in different or multiple languages, and/or be accessible by filters to search for cases by language.

The communications module 250 provides for communication between different components of the resolution forum 130 and the users. The communications module 250 may use protocols for various computers, mobile devices, networks, internets, and the like. The communications module 250 accesses the user database 210 to obtain user communication preferences in order to communicate by different means at different times for during different situations, all set by the user, such settings include vacation settings and preferred means of communication settings.

The preferred means of communication allows the communications module 250 to send communications to users by a preferred method selected by each user. Settings for the preferred means for communicating include text messaging, emailing, phone calls, postal mail, and any other process that can be automated. Also, the preferred means of communication may be set to be time of day sensitive, such as emails to a work email during working hours, and emails to a private email after hours.

Furthermore, the communications module 250 determines if the vacation setting has been set by a user. The vacation settings can be set for a temporary or permanent time until changed by the user, and may be set for different means of communication, such as changing from computer to a phone. This allows users to select how and when communications can be sent by the resolution forum 130. For example, when a user is has busy schedule or does not want to be overly disturbed, the user sets the vacation setting not to be selected as an expert candidate, and if exceptionally busy, the user may optionally set the vacation setting not to be selected as a voter candidate.

Vacation settings allows the resolution forum 130 to reduce unnecessary communications sent by the communications module 250, reduce unwanted communications received by a unwilling user, and speeds up the process to populate experts and/or voters who are otherwise not available to be experts and/or voters, respectively.

In one embodiment, a user may optionally agree to receive all case communications from the resolution forum 130. If so, then during the entire processing of the case, the users is keep up-to-date with automated communications as soon as conveniently possible for the user, as communication means and timing are uniquely tailorable by the user. This allows fast and friendly communications with the resolution forum 130, and helps keeps users interested tuned into case proceedings as they occur, and additionally prompts the user for any pending responses, so as to have fast turnaround for responses. In another embodiment, a user may optionally select to receive case communications while being logged into the resolution forum 130. This allows the user to have control over when communications are to be obtained, thus making organization of the communications simple and easy.

In various embodiments, a user may select to receive communications in multiple ways, such as by logging in for less time-critical communications that do not contain a response request, and at any time by automated communications for communications that contain a response request.

The case module 220 may limit case participation requests to a user to become a voter or an expert, if the user does not respond to a communication requesting a response sent from the communications module 250. For example, if the communications module 250 sends a request to user, due to the user being identified as a candidate expert, and the user does not respond to the request, then after a determination by the case module 220 that the user has not responded or has not responded within a specified time, the communications module 250 does not send any further communications to this user for this specific case. In one embodiment, the case module 220 optionally places a user on a non-responsive list until after a specified time or until after the user communicates to be removed from the non-responsive list, if the user does not respond to a specified number of communications containing a request. For example, if a user has received three requests to be an expert and/or a voter for three different cases, and has not responded to any of these requests, the user is place on the do-not-disturb list for three months.

In various embodiments, if on the non-responsive list, then the resolution forum 130 may communicate with the filter module 230 in other pending or future cases to prevent the user from being selected as an expert candidate and/or a voter candidate for a certain period, or until the user requests a changes of status to be removed from the non-responsive list. Similarly, in other embodiments, a user who has been selected as a voter candidate and who has not responded to the invitation, may be put on the non-responsive list. In other embodiments the case module 220 communicates with the user database 210 to put a user on the non-responsive list.

The display engine/GUI 260 displays pages to the users based on a type of the user and the progress of the case as per the case module 220 to allow for proper communication and functionality of the resolution forum 130. In one embodiment, the display engine/GUI 260 sends different pages to different types of users. For example, the initiator 110 and the respondent 140 will be the only users to view screens relating to the case during document uploading for the issues to be uploaded, and for arguments issues. In another example, the display engine/GUI 260 will send pages to the expert 150 to allow the expert 150 to view argument information, except for any non-approved supporting documents, and to submit an opinion.

In one embodiment, after receiving all of the opinions from the experts, the display engine/GUI 260 limits content of the case to the voter candidate 180 until after the user has accepted to be the voter 170. Content that may be communicated to the voter candidate may be the statement of dispute, or other basic information as decided by the disputers, while all the argument information (except for the non-approved supporting documents) is accessible after becoming a voter 170.

In various embodiments, the display engine/GUI 260 displays information in an orderly, accessible or manageable format, such as by displaying cases by similar grouping, that is, by different legal fields such as property law, business law, etc., or display new cases first, or display active cases first, or to display most recent comments first, and the like. In other embodiments, the display engine/GUI 260 organizes cases by outcome, for example, if a researcher desires to see winning cases in which a pedestrian receives damages in an auto accident case. In other embodiments, the display engine/GUI 260 displays a listing of cases that are open for solicitation by an arbitrator, and open for review by the researcher 190. In some embodiments, a home page of the resolution forum 130 displays a listing of popular cases, so as to allow users to view the popular cases, and of which a disputer could add a catch-phrase, if so desired.

In another embodiment, users are presented a similar page, but have links to different functions being operable or non-operable depending on the user type. For example, the expert 150 may see a link to allow the expert 150 to vote, but the link is non-operable; only operable for the voter 170.

FIG. 3 is a block diagram of the case module 220. The case module manages a case and includes at least two modules such as an initiator module 310, a respondent module 340, an expert module 360, a voter module 370, a votes module 380, and an outcome determination module 390. For example, the case module 220 may include the initiator module 310 and the respondent module 340.

The initiator module 310 receives information provided by the initiator 110 and may assists with the interface provided to the initiator 110, such as, operations, display, communications, filter operations other operations discussed herein, and the like. Similarly, the respondent module 340 operates with the respondent 140 and information provided by the respondent. Also, the expert module 360 may assist with the expert 150, and the voter module 370 may assist with the voter 170 for operations such as display, communications, other operations discussed herein discussed, and the like. In various embodiments, the expert module 360 and the voter module 370, may share and delegate functionality and communication information with the filter module 230 to determine expert candidates and voter candidates, respectively.

In one example of using filters to determine an expert candidate, if a user indicates a willingness to be an expert only if paid, that is to receive money for an opinion, and if a disputer is seeking a non-paid expert, then the expert module 360 will not identify the expert-for-pay user as an expert candidate for the disputer seeing expert-for-free expert.

The voter module 370 identifies voter candidates based on filters, if any, sends invites to the voter candidates, and receives acceptances from the voter candidates.

The voter module 370 obtains a sufficient number of votes as determined initially by the initiator 110, and optionally modified by the respondent 140. That is, the number of voters is determined by initiator 110 when the initiator submits case data, which may be modified by a respondent, if there is a respondent. Having the number of votes being a variable, adds flexibility for the disputers to balance between having a fast resolution and a stronger representation of a population, by have fewer voters or more voters, respectively.

The voter module 370 assists with votes, such as administering ballots to the voters, tallying the votes and performing other operations herein discussed. The outcome determination module 390 formalizes an outcome by, for example, processing damages based on the tallied votes, determining a winner, determining winners for each group of voters based on each of the filter selections of each disputer, other operations discussed herein and the like.

FIG. 4 is a flow diagram of a process for resolving a dispute. In step 410, the initiator module 310 via the resolution forum 130 receives case data from the initiator 110. The case data contains a statement of dispute, and may contain other argument information, filter data, and case parameters, as discussed herein.

In one embodiment, if an initiator 110 does not supply respondent information and desires to have a respondent, then the argument is published on a web-page bulletin board (not depicted) accessible via the network 120 by any user. While posted on the bulletin board, any user may choose to act as the respondent 140. After the respondent module 340 receives case data from the user choosing to be the respondent 140, the case listing is delisted from the bulletin board, and steps 520-590 of FIG. 5 are performed before proceeding to step 420 of FIG. 4, that is, the case would proceed similarly as if the initiator 110 supplied the respondent information. In another embodiment, if posted on the bulletin board, and no other user volunteers to be the respondent, then after a certain amount of time, the case is delisted from the bulletin board, and the case may be purged.

In a further embodiment, the initiator 110 may also act as the respondent 140, as determined initially when the initiator 110 submits case data, in which the process may proceed to directly to step 420, or the initiator 110 may act as the respondent 140 after the case has been posted on the bulletin board. If a user acts as both the initiator 110 and the respondent 140, the user provides both sides of the argument. These embodiments give initiators different options for performing a case under difference situations, such as, if a respondent is difficult to identify or unwilling to cooperate, as for example, in police brutality situation or in a spousal abuse situation.

In step 420, the voter module 370 determines one or more voter candidates, the number being based on the case parameters. In one embodiment, if there are no voter filters provided by the initiator 110, the voter module 370 randomly selects voters. In another embodiment, if only one of the disputers selects voter filters, then the voter filters of the selecting disputer are used to determine the voter candidates. In other embodiments, if both disputers select voter filters, then the voter filters used are split evenly, or if an odd number, the remaining voter is determined using the voter filters selected by the respondent 140.

In step 430, the voter module 370 sends a voter invitation to each the voter candidate 180 as identified by the voter module 370. In one embodiment, if an acceptance is not received from one or more voter candidates, then additional voter candidates are identified, repeating step 420, until a sufficient number of acceptances are received. In another embodiment, the resolution forms send an open invitation to the webpage, where a user who is logged into the resolution forum 130 and meets all the filtering criteria set by the disputers, if any, may select to become a voter, thereby accepting to be a voter online. By supplying the voter candidate 180 with no or minimal argument information, such as only the statement of argument, a fast and easy decision be made on whether to accept the invitation, as the voter candidate 180 would not need to review extensively prior to deciding on participating.

In another embodiment, not depicted, the voter candidate 180 has access to some or all of the argument information prior to deciding to accept the invitation, see step 450 for gaining access to argument information. This may allow the voter candidate 180 to determine whether or not to participate in the case, thereby increasing the likelihood that the participation results in a vote rather than having the participant not submit a vote due to confusion of issue or some other misunderstanding about the dispute.

In step 440, the voter module 370 receives an acceptance from the voter candidate. The voter candidate now becomes the voter 170. In one embodiment, if a user who is selected as a voter candidate does not respond either with an acceptance or a rejection, then the voter module 370 may request the case module 220 to put the user on a non-responsive list as maintained by the resolution forum 130, as discussed herein.

In step 450, the voter module 370 gives the voter access to the argument information. In one embodiment, the voter 170, is limited to voting, that is, no communications the voter 170 and other users of the case are allowed. In another embodiment, not depicted, the voter 170 may optionally submit an opinion for the purpose of persuading other voters.

In a further embodiment, not depicted, the voter 170 may optionally submit an opinion for the purpose of persuading only other voters of which were selecting using the filter information from the same disputer, that is, if a first and second voter were identified as voter candidates using filter information provided by the initiator 110, and a third voter was identified as a voter candidate using filter information provided by the respondent 140, then the first voter could give an opinion to the second voter, but not to the third voter.

In step 460, the votes module 380 receives a vote from the voter. In one embodiment, the votes module 380 sends more invitations than the required votes, which helps ensure that the number of votes is sufficiently met, and may receive votes from voters on a first come first vote acceptance basis. In another embodiment, a voter has a time limit to vote, and if not voted within the time limit, the voter is prevented from voting, and a replacement voter is determined by finding and sending an invitation to another candidate voter. In another embodiment, module functions are combined, such as the voter module 370 and the votes module 380 are combined as one module. In various embodiments, the functionality of the voter module 370, the votes module 380 and the filter module 230 may overlap or be arranged as one module under the case module 220 or the resolution forum 130.

After the number of votes have reached the number-of-votes criteria, as based on the case parameters, then in step 470, the outcome determination module 390 determines an outcome of the case. In one embodiment, the outcome will be a binary result that is for example; yes or no; true or false; or guilty or innocent; or any other binary type of decision as supplied in the argument information.

In another embodiment, the disputer may have the case module 220 to manage a vote that includes multiple selections, such as monetary damages for specific items and/or percentages to represent liability. For example, in a landlord-tenant dispute, the initiator 110 provides items for replacement of furniture at $500, repair of walls at $200, and cleaning of carpet at $300, in which the voter 170 has the option to vote for 0%, 25%, 50%, 75% or 100% recovery for each item. As an example of result determination, if voting results were based on a consensus of voters for 50% for replacement of the furniture, and 0% for the others, then the outcome determination module 390 would calculate the vote for a monetary recovery of $250.

In one embodiment, the outcome determination module 390 determines a percent-liability award based on a commonality of votes, such as a majority, as being over 50% of the votes, a simple majority, as being a relative majority, or a super majority, as being a predetermined percentage over 50%, which may be set by one or both of the disputers. Continuing with the above landlord-tenant example, for the cleaning of the carpet, if a simple majority is used, and the votes from five voters included 0%, 0%, 75%, 50%, and 100%, then the outcome determination module 390 would determine a monetary outcome to be $0.

In other embodiments, the outcome determination module 390 determines a percent-liability award based on an average vote, such as, the mean, a medium, or a weighted average, as having votes from voters determined by filters selected by one of the disputers count more than votes from voters determined by filters selected by the other disputer, in which both disputers would have set or an opportunity to reject the setting. For example, if 60% of voters voted for the initiator, then the imitator could collect 60% of the damages.

In further embodiments, the votes are not weighted equally, as determined between the disputers. For example, if one disputer uses filters and the other does not or uses minimal filters, then to make the outcome more fair, the votes from voters who had fewer filters in the determination may be weighted at 20% more than the votes of the other voters.

In various embodiments, the disputers could enter equations rules as to base an outcome. These options and flexibility allow the disputers to determine a fair and acceptable way to determine an outcome. In other embodiments, disputers could agree to perform duties or abstain from rights based on an outcome, such as, for example, if the respondent loses, then the respondent agrees to remove the fallen tree from the property of the initiator. This allows for a broad range of outcomes, both conventional and non-conventional, as agreed to by both disputers.

In one embodiment, during case proceedings or after the case is completed (not depicted), the resolution forum 130 may purge the case if the initiator 110, alone if no respondent 140, or the initiator 110 and the respondent 140, if mutually agreed, submit a request, singly or separately, to purge the case. If only one of two disputers, or if any of the disputers where there are several do not agree to purge the case, then the case will still remain in the system.

In various embodiments, the outcome determination module 390, upon a tie and/or by agreement of the disputers either early in the case or at the time of the tie, determines another voter candidate to obtain another vote by repeating steps 420-470, so as to break the tie. In other embodiments, as based on the case parameters selected by the disputer, a tie breaking vote may be made by one voter or a majority of the group of additional voters, that is for example, if there is a tie, the outcome determination module 390 messages the voter module 370 to identify five more voter candidates, and uses the these additional votes to determine the outcome.

The outcome determination module 390 is flexible and adaptable to allow a variety of outcomes to be selected from the resolution forum 130, whereas only a few were described, or originated by the disputers, thus allowing for an case appropriate and a mutually agreeable method to reach an outcome. Additionally, the disputers may optionally put money into an escrow, either with the resolution forum or a third party escrow service, and after an outcome has been decided, the resolution forum initiates a transfer of escrowed funds accordingly.

FIG. 5 is a flow diagram for joining a respondent and obtaining respondent case data. Steps 510-575 may occur within step 410 of FIG. 4. In various embodiments, the respondent 140 is optional, and the case may proceed without joining the respondent 140. In step 510, an invitation to join a case is sent to a respondent 140. In one embodiment, the invitation may be prepared and sent by the respondent module 340 via the resolution forum 130. In another embodiment, the invitation is sent by the initiator 110 outside of using communications of the resolution forum 130, such as by giving reference information, such as a link or case code created by the resolution forum 130, to the potential respondent, in which the potential respondent would create a user account, if necessary, and join as a party using the reference information.

In step 520, in various embodiments, if the initiator invites a user to become the respondent and the respondent does not accept the invitation, the case is dismissed, step 530. The resolution forum will not force a case upon a respondent 140 if the respondent does not agree with the terms. Otherwise, if the respondent module 340 receives an acceptance to join the case, then the in step 540, the respondent module 340 notifies the initiator 110 of the acceptance.

In step 550, the respondent module 340 receives respondent case data, that is, case data generated by the respondent 140, such as argument information and case parameters, as discussed herein.

In step 560, the respondent module 340 receives one or more initiator supporting documents, if any.

In step 565, the respondent module 340 receives a non-acceptance of a supporting document, in one embodiment. Either the initiator may submit a non-acceptance of the respondent supporting document or the respondent may submit a non-compliance of the initiator supporting document. Some examples of a non-acceptance of a document are supporting documents that contain personal information, such as, an address or other information not related to the case.

In various embodiments, a non-acceptance may contain conditions for acceptance. The conditions for acceptance dictate the reasons for non-acceptance, and if the issuing party modifies or redacts the objected to information of the non-accepted document, then the receiving party may accept the document. Others examples of a condition for acceptance may be a request to remove an entire supporting document; suggest to replace a supporting document with a more accurate or easier-to-understand supporting document, and any other request to allow the case to move forward and/or to allow the case to proceed more efficiently.

Still further examples of a condition for acceptance may be if the provider of the supporting document also provides support for the validity of the supporting document, that is some statement or evidence to verify the supporting document, such as by providing certified statements from eyewitnesses, affidavits, or other tools used for discovery during court proceedings, all of which could potentially be used by a court if the case is presented before a court. This may help to heighten the disputers review, attention and collection of supporting documents, thereby increasing the probability of the users to come to a resolution.

In various embodiments, a disputer waives an opportunity to submit a non-acceptance for a support document if the disputer does not submit the non-acceptance within a particular time.

In one embodiment, a non-acceptance of a document may be issued with a condition of pre-approval, if the approving party feels that the information is non-prejudicial or non-sensitive information is the reason for non-acceptance. This would allow the document to be approved if the issuing party addresses the condition, would not require an additional an acceptance of the other party, and thus move the case forward faster than if the other would need to approve the document.

In step 570, the respondent module 340 communicates to the other disputer of the non-acceptance.

In step 575, the respondent module 340 receives a response to the non-acceptance. If the response is denial of the non-acceptance, then the case is dismissed. If the response is a confirmation of the non-acceptance, then the respondent module 340 logs the confirmation and proceeds with the case in step 585. In one embodiment, the other disputer may offer a counter-acceptance rather than confirming or denying. The counter-acceptance may be similar to the non-acceptance, and has the intent to move the case forward. For example, if the non-acceptance by a disputer is to remove a supporting document entirely, the counter-acceptance proffered by the other disputer may be to only remove certain pages from the supporting document.

In one embodiment, in steps 565-575, the respondent module 340, handles non-acceptances of case parameters. For example, the initiator 110 sets the case to be a public case. Then after reviewing the case parameters, the respondent 140 issues a non-acceptance of the case being public, and requests the case to be private. Thereafter the initiator 110 may change the case to be private, or optionally choose to purge the case, submit a counter-offer, or let the case go abandoned.

In another embodiment (not depicted), similar to steps 565-575, the disputer may identify the supporting document as accepted, contingent or rejected. If accepted, the supporting document is entered into the case. If the supporting document is marked contingent, a dialogue box to post messages allows the marking disputer to comment why the document was marked contingent. The other disputer can either respond with a counter suggestion or take note and resubmit the supporting document with changes that address the issues of the marking disputer. For example, if a photo is uploaded that shows a license plate, such as a personal plate, and the respondent 140 can mark contingent and type a comment “if you redact my license plate in the photo, I will accept it.” The communications may continue until a new document is uploaded. Once the initiator 110 reloads the document or loads an entirely new document, the same options to accept, contingent or reject options remain.

In step 585, the respondent module 340 determines if there are any additional supporting documents. In one embodiment, case criteria are used to constrain the acceptance of supporting documents, such as time limits, examples being one month to submit supporting documents and two weeks to submit a non-acceptance. If there are no additional supporting documents or non-acceptances of supporting documents, then the respondent module 340 proceeds to stop 590.

In step 590, the respondent module 340 closes review of supporting documents. In various embodiments, the process continues with step 420 of FIG. 4, the step of determining one or more voter candidates.

FIG. 6 is a flow diagram for obtaining an expert and an opinion. In step 610, the expert module 360 via the resolution forum 130 receives an expert request from one or both disputers, and may receive one or more expert filters, as discussed herein.

In step 620, the expert module 360 determines an expert candidate by having the expert filters applied by the filter module 230 used with the data stored in the user database 210, as discussed herein.

In step 630, the expert module 360 sends an invitation via the communications module 250 to the expert candidate 160, which is similar to that of step 430 by the voter module 370.

In step 640, if the expert module 360 receives an acceptance within any time constraints, then the expert candidate is identified as an expert. In one embodiment, the time constraints to receive an acceptance may be default time constraints, such as, for example a five days, a week or a month. In another embodiment, the time constraints are set by the initiator 110 for the experts to give an opinion for the initiator 110, and set by the respondent 140 for the experts to give an opinion for the respondent 140. In a further embodiment, both disputers may agree to a same time constraints, as initially proffered by the initiator 110. If an acceptance is not received within a time constraint, then the expert module 360 repeats steps 620 and 630 until an acceptance is received.

In one embodiment, if a user who is selected as an expert candidate does not respond either with an acceptance or a rejection, then expert module 360 may request the case module 220 to put the user on a non-responsive list as maintained by the resolution forum 130, as discussed herein.

In step 650, the expert module 360 communicates with the document database 240 via the case module 220 that the expert 150 is to be given access to the argument information. In one embodiment, the expert 150 reviews the argument information provided by both disputers. In another embodiment, as optionally set by the disputers, the expert 150 reviews only the argument information provided by the requesting disputer, that is for example, if requested by the initiator 110, then the expert 150 would only review the initiator supplied information.

In step 660, the expert module 360 determines if the opinion was received in time. After reviewing the argument information, the expert 150 prepares and submits an opinion, which if received by the expert module 360 in time, step 660, then proceeds to step 670. If the expert module 360 does not receive the opinion in time, then the expert module 360 repeats steps 620-650, so as to obtain an expert opinion. In one embodiment, if the export module 360 does not receive the opinion in time, then the expert module 360 reports the non-receipt to the case module 220 so as to add the user to the non-responsive list, as discussed herein.

FIG. 7 is a flow diagram for obtaining a sufficiency of voters and a sufficiency of votes. In step 710, the voter module 370 receives case data from the initiator 110 and if applicable, from the respondent 140. The case data received contains filter data for the filter module 230 to determine voter candidates, argument information to be provided to the voters, and case parameters to determine the number of voters and/or votes. The case data is further discussed herein.

In step 720, the voter module 370 determines a voter candidate. In one embodiment, if a user has already accepted to be an expert, then the case module 220 flags the user as being part of the case, which is used to prevent this user from being selectable as a voter candidate, thereby preventing the user from also being both an expert and a voter.

In step 730, the voter module 370 sends an invitation to the voter candidate. In step 740, the voter module 370 receives an acceptance from the voter candidate.

If no, then the voter module finds determines another voter candidate, to obtain another acceptance, as described herein, by repeating steps starting from step 720.

In step 750, the voter module 370 provides argument information to the voters. After reviewing the argument information, the voter can then make an informed vote as to how the case should be decided.

In step 760, the voter module 370 receives votes from the voters. In one embodiment (not depicted), if the voter module 370 does not receive a vote from a voter within a certain time constraint set by a disputer and/or by the case module 220, then the voter module 370 determines another voter candidate, to obtain another voter, as described herein, by repeating steps starting from step 720.

In step 770, the voter module 370 determines if there are a sufficient number of votes. If the voter module 370 does not receive a sufficient number of votes, then the voter module 370 determines another voter candidate, to obtain more votes, as described herein, by repeating steps starting from step 720.

In another embodiment, if there are an insufficient number of voter candidates, as identified by the filter module 230, or if there are an insufficient number of votes received by the voters, as determined by the voter module 370, then the voter module 370 sends a communication to the respective disputer requesting a relaxation of the filters, the voters, or the votes. The relaxation may be a request, such as, to reduce the number of votes or voters thereby allowing for a faster dispute resolution than if waiting for more of the voters to vote or for new users to join and qualify, or to remove some of the filters to allow more users to qualify as voter candidates. As an example, if the respondent initially requests 1000 votes and applies many filters, whereby only 98 voter candidates are identified, then the voter module 370 suggests in a communication to the respondent to reduce the number of voters to 98, thereby allowing the process to progress.

In yet another embodiment, the disputer assigns priorities to filters, whereby some of the filters may be set to required, and others may be set to preferred, or the filters may be set in an order of preference, whereby the filter module 230 identifies voter candidates based on optimizing the preferences of the filters selected by the disputer. As an example of a preferred filter selection, the initiator gives highest priority to filter one, second highest priority to filter two, and lowest priority to a last filter, whereby the filter module 230 identifies voter candidates based on filter one first, then from those identifies a subset of voter candidates based on filter two, and so on.

In another embodiment, users are assigned ratings. User ratings may increase based on activities of the resolution forum 130 or other user positive input regarding the user, and may decrease based on negative conduct within the resolution forum 130 or other user negative input regarding the user. Examples of ways to increase a rating are positive conduct, such as, logging in frequently, voting within a required time limit, submitting responses on time or any other activity in accordance with parameters as discussed herein. Examples of when another user rates a user positively is to identify the user for positive behavior, such as, by responding above an average response, as when an expert provides an outstanding opinion, responding promptly, or any other action as appreciated by the other users. Examples of negative conduct, which may decrease a user rating, include not responding, not voting in time, and other activity which unnecessarily increases the time to resolve a dispute. Ratings may be used to give preference to users in the identification of voter candidates and expert candidates, as discussed herein. In one embodiment, users may provide rating input by clicking on a “+” sign to increase a rating or a “−” sign to decrease a rating, the signs being supplied on a webpage and associated with and accessible by the users participating in a case.

In step 780, the voter module 370 the outcome of the vote is determined, as discussed herein. In step 790, the voter module 370 the outcome is provided to users, as discussed herein.

The resolution forum 130 allows any user to debate a dispute or a topic of discussion in a format that removes an immediate emotional element, sometimes present when confronting an adversary in person, to allow for an orderly and constructive debate. Providing a tool for users to communicate, debate and understand differences between the users, may resolve the differences.

The resolution forum 130 allows for a fast, easy, inexpensive, hands-on approach to resolving disputes; encourages users to become more familiar with the topic of the dispute, both by research and shared opinions; promotes mutual consideration of disputers to resolve a dispute; organizes argument information for fast and easy access; and provides another alternative approach to resolve disputes.

In various embodiments, the methods and systems resolves an issue or dispute dynamically as after the resolution forum 130 receives user input from various users, the resolution forum 130 dynamically communicates with users depending on the user input to meet the given conditions set by users. For example, if the number of votes has not reached a given minimum, the resolution forum 130 will set out additional communications to obtain the minimum, or may alter how the resolution is to be determined, as discussed herein.

In one embodiment, completed cases may be taken to a court house as evidence of pre-trial mediations attempts. This allows for disputers to refine and prepare cases as adverse parties, rather than just as separate parties, and present to courts for efficient processing and determination. Preparation with knowledge of the strategy of the opposing party will allow for less surprises and mutual understanding of the opponents objectives prior to a judge reviewing the case, thereby potentially resolving a court case faster than if otherwise not prepared, thus saving the judicial system time and effort.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined here may be applied to other embodiments without departing from the spirit or scope of the invention. Thus, the present invention is not intended to be limited to the embodiments shown here but is to be accorded the widest scope consistent with the following claims and the principles and novel features disclosed here.

What is claimed is:

1. A dispute resolution method comprising:
receiving case information from an initiator, wherein the case data contains argumenta information;
based on the case information, determining at least one voter candidate;
sending a voter invitation to each of the at least one voter candidate;
receiving an acceptance to be a voter from a voter candidate of the at least one voter candidate;
supplying the argument information of the initiator to the voter;
receiving a vote from the voter, and
determining an outcome based on at least the vote.

2. The dispute resolution method of claim 1, further comprising:
based on the initiation data, sending a respondent invitation to a respondent;
receiving an acceptance to the respondent invitation from the respondent;
notifying the initiator of the acceptance;
receiving argument information from the respondent; and
supplying to the voter access to the argument information of the respondent.

3. The dispute resolution method of claim 2, further comprising:
after receiving a closing argument from the initiator or a closing argument from the respondent, sending to the other of the initiator or the respondent, a request for a closing argument; and
receiving the closing argument from the other.

4. The dispute resolution method of claim 2, further comprising:
after receiving at least one initiator document of the argument information, preventing access by the voter to the at least one initiator document;
receiving from the respondent an approval of the at least one initiator document; and
after receiving the approval, supplying to the voter access to the least one initiator document.

5. The dispute resolution method of claim 2, further comprising:
after receiving at least one initiator document of the argument information, receiving from the respondent an approval for the at least one initiator document; and
supplying to the voter access to the approved at least one initiator document.

6. The dispute resolution method of claim 2, further comprising:
after receiving at least one initiator document of the argument information, receiving from the respondent a conditional approval to the at least one initiator document;
receiving a modified version of the at least one initiator document;
receiving from the respondent an approval for the modified version of the at least one initiator document; and
supplying to the voter access to the approved modified version.

7. The dispute resolution method of claim 1, wherein the case data comprises a number of voters, the method further comprising:
determining if the number of voters is equal to a total number of acceptances received from the at least one voter candidate; and
if the determination is that there are fewer acceptances than the number of voters, repeat until equal,
determining another at least one voter candidate; and
receiving at least one favorable response from the another at least one voter candidate.

8. The dispute resolution method of claim 1, wherein the case data comprises a number of voter, the method further comprising:
determining if the number of votes is equal to a total number of votes received from voters; and
if the determination is that there are fewer received votes than the number of votes, and time has expired for the voter to vote, repeat until equal,
determining another at least one voter candidate;
receiving at least one favorable response from the another at least one voter candidate;
receiving an acceptance from the voter candidate of the at least one voter candidate; and
receiving a vote from the voter.

9. The dispute resolution method of claim 1, wherein the case data comprises a number of experts, the method further comprising:
determining if the number of experts is equal to a total number of acceptances received from the at least one expert candidate; and
if the determination is that there are fewer acceptances than the number of experts, repeat until equal,
determining another at least one expert candidate; and
receiving at least one favorable response from the another at least one expert candidate.

10. The dispute resolution method of claim 1, further comprising:
based on the initiation data, creating a case; and
allowing access to the case by users.

11. A dispute resolution system comprising:
a receiver configured to receive case information from an initiator, wherein the case data contains argumenta information;
a voter determiner configured to, based on the case information, determine at least one voter candidate;
a sender configured to send a voter invitation to each of the at least one voter candidate;
a receiver configured to receive an acceptance to be a voter from a voter candidate of the at least one voter candidate;
a supplier configured to supply the argument information of the initiator to the voter,
wherein the receiver is further configured to receive a vote from the voter; and
a determiner configured to determine an outcome based on at least the vote.

12. A non-transitory computer readable storage medium having stored thereon, a computer program, the computer program when executed by a computer causes the computer to perform dispute resolution steps comprising:
receiving case information from an initiator, wherein the case data contains argumenta information;
based on the case information, determining at least one voter candidate;
sending a voter invitation to each of the at least one voter candidate;
receiving an acceptance to be a voter from a voter candidate of the at least one voter candidate;
supplying the argument information of the initiator to the voter;
receiving a vote from the voter, and
determining an outcome based on at least the vote.
